(19) United States
(12) Patent Application Publication
(10) Pub. No.: US 2018/0025383 A1
(43) Pub. Date: Jan. 25, 2018

(54) MIXED REALITY SYSTEM FOR IDENTIFICATION OF A COMMERCIAL OFFERING

(71) Applicant: David M. Tumey, Coral Springs, FL (US)

(72) Inventor: David M. Tumey, Coral Springs, FL (US)

(21) Appl. No.: 15/655,140

(22) Filed: Jul. 20, 2017

Related U.S. Application Data
(60) Provisional application No. 62/365,967, filed on Jul. 22, 2016.

(51) Int. Cl. G06Q 30/02; G06Q 20/22

(52) U.S. Cl. CPC G06Q 30/0259; G06Q 20/22; G06Q 30/0252; G06Q 30/0253; G06Q 30/0267; G06Q 30/0268

(57) ABSTRACT

A response to an advertisement driven stimulus is effected by locating a portable Mixed Reality (MR) device at a terrestrial position at a point in time; identifying a fixed point advertisement in proximity to the portable MR device based upon the device's terrestrial position; and providing a response specific to the fixed point advertisement. The point in time is determined by a signal from the portable MR device with respect to an advertisement, whereafter the MR device is located by receiving a navigational signal. Communication is automatically established with a central data server where the fixed point advertisement is identified by comparing the terrestrial position of the portable MR device with a plurality of tabulated positions of fixed point advertisements. A unique identifier associated with the portable MR device and position of the device are utilized by the data server to tailor a specific response to the advertisement based stimulus.

### FIELD OF THE INVENTION

The present invention relates to electronic commerce. More particularly, the invention relates to a mixed reality system for acting upon a consumer's purchase impulse utilizing a unique combination of mixed reality display technology, navigational satellite or other automated positioning systems, wireless communications, a public WiFi system or a public data network system or other substantially equivalent communication system, the Internet and existing commercial delivery services.

### BACKGROUND OF THE INVENTION

According to industry statistics, the average consumer in the United States is exposed to over 14,600 terrestrially-fixed advertisements per year. For example, in the United States alone, the top five billboard companies own an estimated 575,000 roadside signs. Worldwide, this equates to an inestimable amount of time spent viewing advertisements each day by members of the consuming public. Advertisers, however, have not overlooked these staggering statistics. Recognizing the opportunities offered by modern technology, the represented advertisers typically include QR codes, Twitter hashtags, Facebook ID, telephone contact information and Internet web page or electronic mail addresses in addition to physical directions to an outlet for the advertised goods or services. In this manner, consumers are better able to make use of their time for gaining product information or even consummating the purchase of a desired product or service.

Notwithstanding advertisers' heightened efforts to reach the millions of smart phone equipped, Internet savvy consumers passing terrestrially-fixed advertisements, fixed-position advertising still suffers relative disadvantages. Most obvious among the disadvantages is the necessity to remove significant attention from the task the consumer is directly engaged in (e.g., walking, jogging, biking, driving) to obtain an Internet addresses or telephone number and/or to place a cellular telephone call or send a text. Additionally, in the case of the more careful consumer who chooses to follow-up on the purchase impulse after arriving at a fixed destination, the advertiser is at risk that that the consumer will lose the purchase impulse due to passage of time or will forget the necessary contact information. Finally, while the Internet provides an increasingly popular channel for access to information without the fear of high pressure sales inherent to voice calling or visits to a dealer in the advertised goods or services, very few consumers will stop what they are doing to make an impulse purchase at the time a fixed-position advertisement is viewed. Further, with respect to a roadside billboard, it is at least debatable whether such activity is even desirable in light of our present concerns for the impact that that the activity may have on traffic safety.

It is therefore an overriding object of the present invention to improve over the prior art by providing a method and apparatus by which the commercial impact of terrestrially-fixed advertising may be dramatically increased. It is a further object of the present invention to provide such a method and apparatus that is also extendable to other advertising opportunities such as, for example, Internet, television or radio broadcast advertising. It is yet another object of the present invention to provide such a method and apparatus that is simple to implement, requiring no significant initial investment by the advertiser and that requires minimal or no intervention by the service provider for change of advertising content. Finally, it is an object of the present invention to provide such a method and apparatus wherein the consumer can safely take advantage of an advertised commercial offering while engaged in an unrelated primary task.

### SUMMARY OF THE INVENTION

In accordance with the foregoing objects, the present invention—a Mixed Reality (MR) method for providing a response to an advertisement driven stimulus—generally comprises locating a portable MR viewing device at a terrestrial position at a point in time; identifying a fixed point advertisement in proximity to the portable MR device based upon the device's terrestrial position; and providing a response specific to the fixed point advertisement. The point in time is determined by activation of a signal associated with the portable MR device, such as a brain-actuated signal, or a switch or button provided thereon. The MR device is located by receiving a navigational signal, such as that provided by the Global Positioning System (GPS). To this end, the portable MR device incorporates a GPS receiver.

The fixed point advertisement is identified by comparing the terrestrial position of the portable MR device with a plurality of tabulated positions of fixed point advertisements. The tabulated positions are maintained in a central database on a localized data server with which the portable MR device is adapted to remotely communicate. This communication may be by any wireless data transmission system, but preferably is through a public WiFi system, or a public data network as accessed by a smart phone integral with the portable device. In order to achieve maximum benefit from the present invention, the communication should be automatically initiated upon activation of the signal associated with the portable MR device. This communication, however, may follow a delay at the operator's option.

Because the portable MR device comprises a unique identifier, the response may be tailored not only to the identified fixed point advertisement but also to the portable MR device with which the advertisement is identified. To this end, one response comprises transmitting an electronic message to a predetermined address, the content of the electronic message being determined by the identification of the fixed point advertisement and the predetermined address being determined by the unique identifier. Similarly, another response comprises transmitting an electronic message to a predetermined address, the content of the electronic message being determined by the unique identifier and the predetermined address being determined by the identification of the fixed point advertisement. Finally, although many other responses are contemplated within the scope of the present invention, the response may also comprise paying for goods or services, the goods or services being determined by the identification of the fixed point advertisement and payment being based upon the unique identifier.

Finally, many other features, objects and advantages of the present invention will be apparent to those of ordinary skill in the relevant arts, especially in light of the foregoing discussions and the following drawings, exemplary detailed description and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 shows, in a functional block diagram, the preferred embodiment of the mixed reality system for identification of a commercial offering as implemented according to the present invention and, in particular, shows the interfaces between the user side and the processing side thereof;

FIG. 2 shows, in a functional block diagram, details of the implementation of the preferred embodiment for the processing side of the system of FIG. 1;

FIG. 3 shows, in a functional block diagram, details of a first configuration for the preferred embodiment of the user side of the system of FIG. 1;

FIG. 4 shows, in a functional block diagram, details of a second configuration for the preferred embodiment of the user side of the system of FIG. 1;

FIG. 5 shows, in a functional block diagram, details of a third configuration for the preferred embodiment of the user side of the system of FIG. 1;

FIG. 6 shows, in a functional block diagram, details of a fourth configuration for the preferred embodiment of the user side of the system of FIG. 1;

FIG. 7 shows, in a functional block diagram, details of a fifth configuration for the preferred embodiment of the user side of the system of FIG. 1;

FIG. 8 shows, in a functional block diagram, details of a sixth configuration for the preferred embodiment of the user side of the system of FIG. 1;

FIG. 9 shows, in flowchart, an overview of the preferred method of operation of the system of FIG. 1;

FIG. 10 shows, in flowchart, details of the resolve target location step of the process shown in FIG. 9;

FIG. 11 shows, in flowchart, details of the provide service step of the process shown in FIG. 9;

FIG. 12 shows, in flowchart, details of the advertiser's account setup and maintenance functions of the system of FIG. 1;

FIG. 13 shows, in flowchart, details of the user's account setup and maintenance functions of the system of FIG. 1;

FIG. 14 shows, in a functional block diagram, details of an extension of the concepts embodied by the present invention; and

FIG. 15 shows, in flowchart, details of a further extension of the concepts embodied by the present invention.

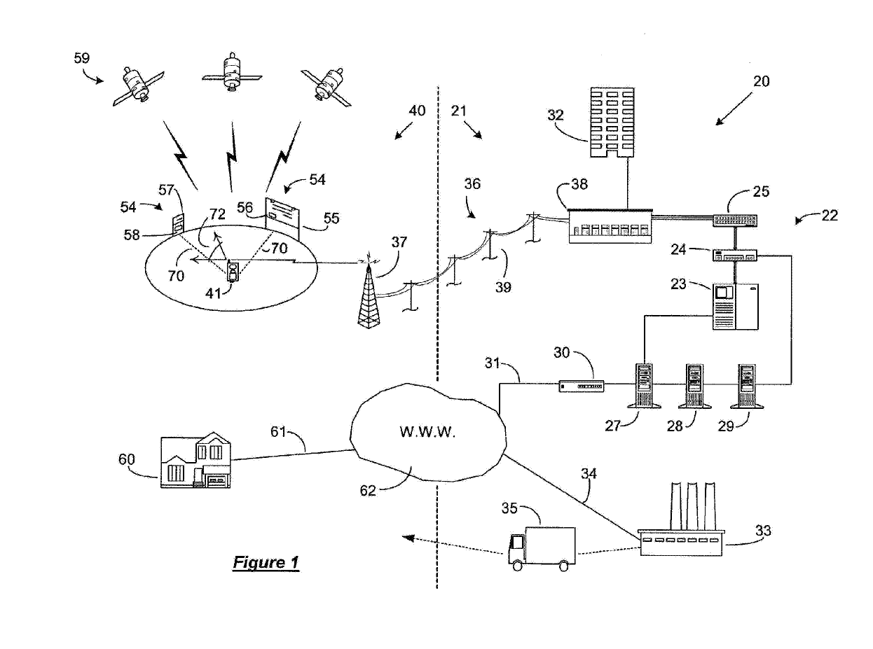

### DETAILED DESCRIPTION OF THE PREFERRED EMBODIMENT

Although those of ordinary skill in the art will readily recognize many alternative embodiments, especially in light of the illustrations provided herein, this detailed description is exemplary of the preferred embodiment of the present invention, the scope of which is limited only by the claims appended hereto.

Referring now to the Figures, a mixed reality system for identification of a commercial offering 20 is shown to generally comprise a user side 40 for collection of a user's commercial intentions and a processing side 21 for acting upon those intentions. The user side 40 is preferably linked to the processing side 21 through a publicly accessible data network 36. As will be better understood further herein, the user's location is captured by providing a signal from a brain-actuated control device 48a or a switch/button 48b on a location capture unit 41 when the user desires more information about a product advertised on a closely located fixed position advertisement 54. This location information is then transmitted through the public data network 36 to the processing side 21 where an information center 22 may interpret and act upon the user's desire. As also will be better understood further herein, the user may be connected by wireless telephone 42 to a business telephone call center 32; order a product from a manufacturer's distribution center 33; or participate in an interactive, prompt-based cellular telephone call with the information center 22. Additionally, the user may interact with the information center 22 via a blended computer-generated virtual image or images associated with the commercial offering, for example, a 3D holographic animated character could appear in the user's visual field to complete the transaction, all of which could take place while the user is engaged in an unrelated primary task.

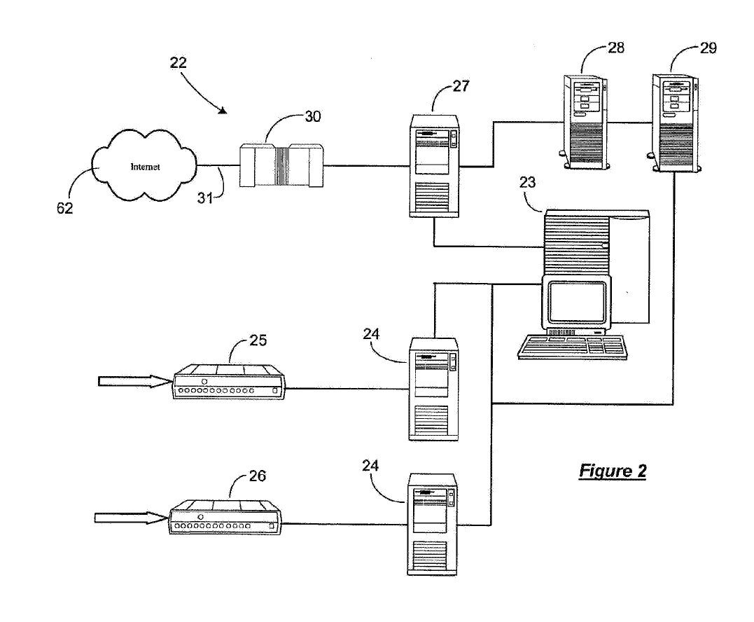

As shown particularly in FIG. 2, the information center 22 generally comprises a data server 23 in communication with the public data network 36 through one or more automated answering units 24 and in communication with users and/or advertising clients through a connection 31 to the Internet 62. In the preferred embodiment of the present invention, an automated answering unit 24 is adapted to receive calls from a multi-port voice modem 25 and/or a digital interface 26 to the public switched telephone network 36. As will be better understood further herein, when a user depresses the “click” button 48 on a location capture unit 41 a wireless or other telephone communication is initiated with the information center 22 through, for example, a cellular cell site 37 connected to a dial central office 38 over telephone land lines 39. This communication is then answered by the automated answering unit 24 through the multi-port voice modem 25 or digital interface 26. Collected information is then processed upon the data server 23 as detailed further herein. In most cases, this processing will result in the transmission of an electronic mail message through the Internet 62. In the preferred embodiment of the present invention, connectivity to the Internet 62 is maintained by a web server 27 through a fire-walled router 30. A separate electronic mail server 28 is provided in communication with the web server 27 in order to distribute processing load. Likewise, because the electronic mail may often comprise multi-media components, a separate multi-media server 29 is preferably provided in communication with the electronic mail server 28.

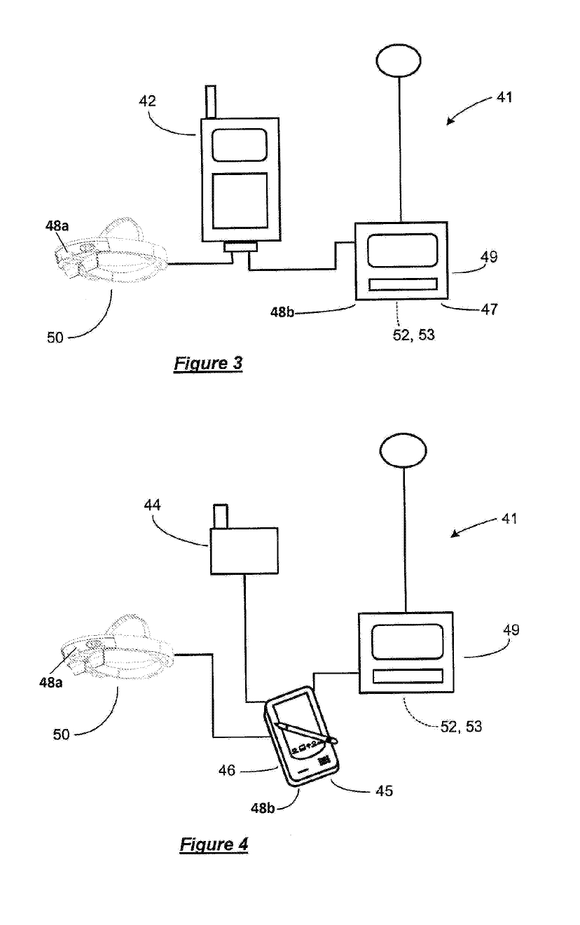

As shown in FIGS. 3 through 8, the location capture unit 41 of the present invention may take any of a number of configurations, the only critical requirement being that the location capture unit 41 be able to accurately determine the user's position and, thereafter, transmit the position information to the information center 22. As shown in FIG. 3, one such configuration may comprise a wireless telephone 42, which may be of the cellular, satellite, radio or other variety, linked with a global positioning satellite system (“GPS”) receiver 49. A data capture unit 47, which may be co-located with the GPS receiver 49, acquires and stores the user's position data, as determined from a transmitting navigational satellite system 59, when the brain-actuated control device 48a signal is generated or switch/button 48b is depressed. As will be better understood further herein, the data capture unit 47 may also comprise an interface to a directional indicator 52, such as a flux gate compass 53, for provision of orientation information to the information center 22. Finally, each configuration of the location capture unit 41 is provided with a mixed reality headset 50 for enhanced implementation during use of the present invention. Headset 50 may integrally include an array of high-impedance dry scalp electrodes required for the brain-actuated control device 48a. It is noted that the mixed reality headset 50 may comprise such a device as of these commercially available under the trademarks “HoloLens” and “Magic Leap”.

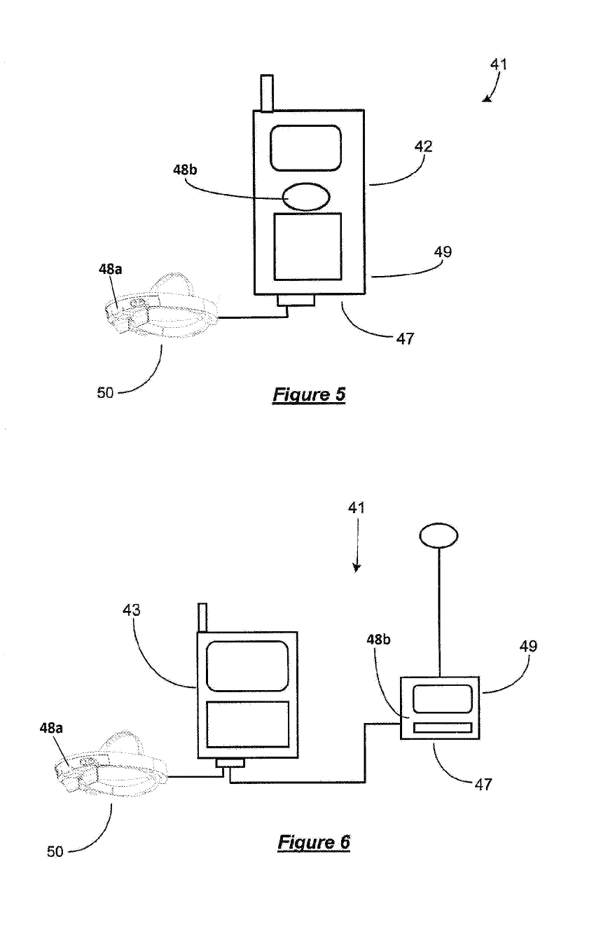

In the configuration of FIG. 4, the location capture unit 41 is shown to comprise a wireless modem 44 and portable computer 45, such as a handheld computing device 46, in place of the wireless telephone 42. On the other hand, a handheld computing device 46 may be utilized to take advantage of a user's existing wireless telephone 42 and GPS receiver 49, such as are each now commonly installed as part of a vehicle's built-in communications and navigation systems. In this case, an interface port may be provided whereby the infrared or wireless short range communications capability, e.g. IR Blaster or Bluetooth, as presently implemented in many handheld computing devices 46, may be utilized to establish communication between the wireless telephone 42 and GPS receiver 49 and the handheld computing device 46. As will be recognized by those of ordinary skill in the art, the necessary software for implementation of the present invention may reside entirely within the handheld computing device 46 or may be distributed between the handheld computing device 46 and the interface port. Finally, the interface port also preferably comprises a holder for the handheld computing device 46, thereby facilitating access to the system while driving or engaging in similar activity. Finally, it is noted that the handheld computing device may comprise such a device as of these commercially available under the trademark “PALM.” Those of ordinary skill in the art will recognize, however, that other substantially equivalent devices are also presently commercially available and appropriate for implementation of many of the features of the present invention.

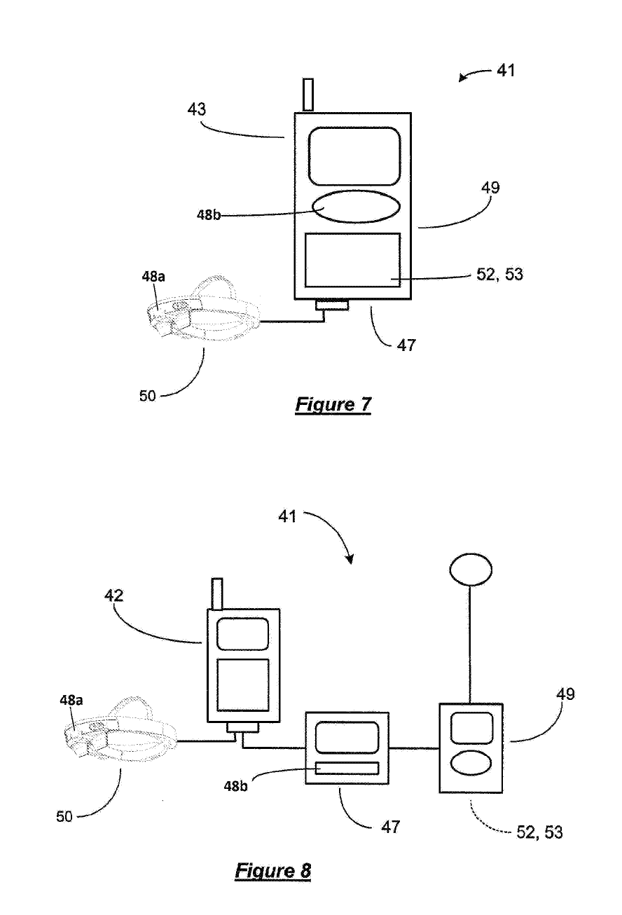

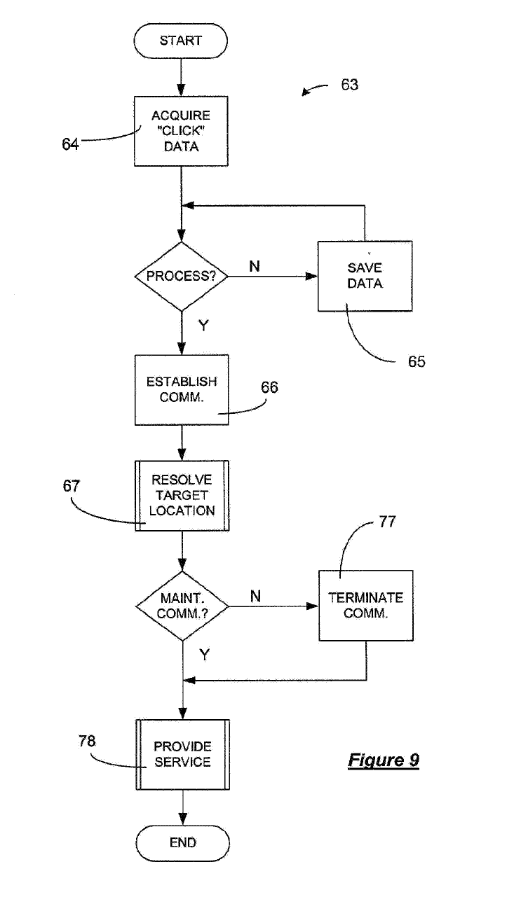

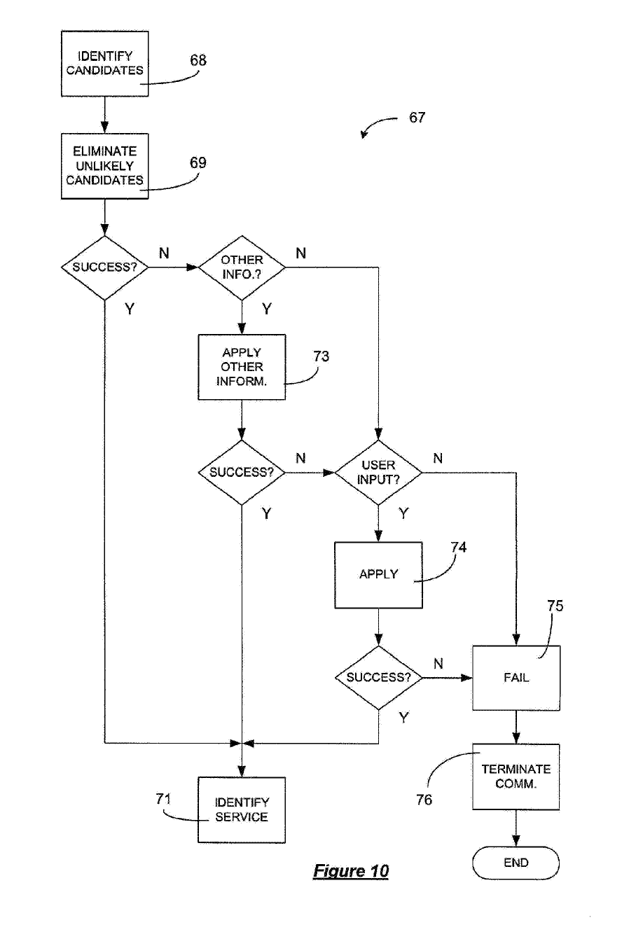

As particularly shown in FIG. 5, the various components of the location capture unit 41 may also be provided within a highly integrated wireless telephone 42 of FIG. 5 having a GPS receiver 49 and data capture unit 47 located therein. As shown in FIG. 6, the wireless telephone 42 may also be replaced with a web browser capable wireless telephone 43. Likewise, the web browser capable wireless telephone 43 may be further integrated to include the GPS receiver 49 and data capture unit 47, as shown in FIG. 7. In yet another configuration, however, the data capture unit 47 may provide an interface between a standard wireless telephone 42 and an existing GPS receiver 49, such as may form a part of an existing in-dash automobile navigation system. This configuration is shown in FIG. 8. In any case, it is to be understood that the location capture unit 41 may combine any of the forgoing features as well as other features not specified so long as the unit 41 has the capability to collect user location information and to transmit the collected information to the information center 22.

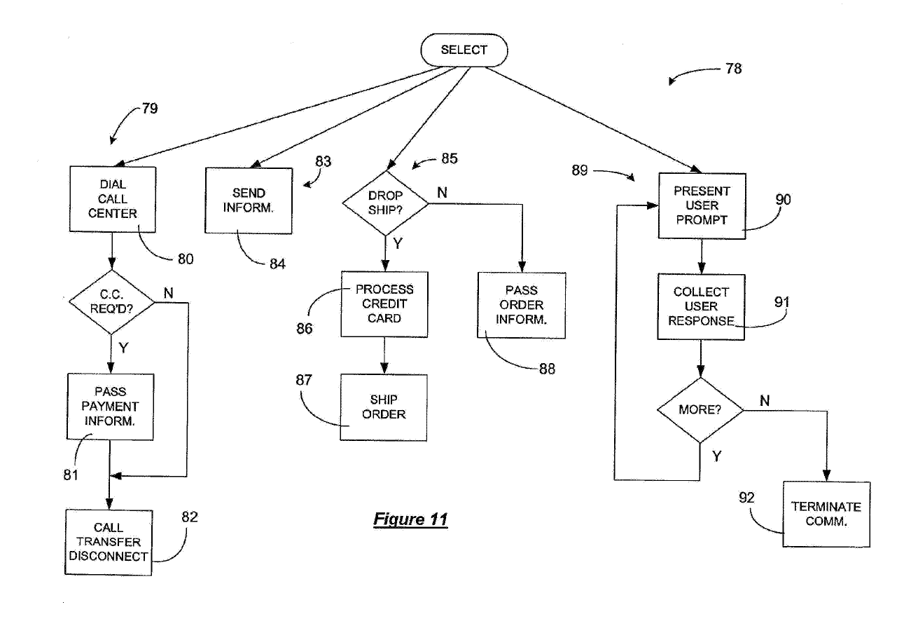

Turning now to FIG. 9, the preferred method for operation 63 of the present invention is detailed. In the first step of operation 64, the user produces a signal either via brain-actuated control device 48a or switch/button 48b on the location capture unit 41, which causes the acquisition of the user's present location from the GPS receiver 49. If the user's wireless telephone 42, or other communication device 44, is in use or if the user wishes to process the request at a later time, the acquired data is then saved 65 within the location capture unit 41. In any case, when the user is ready to process the request, communication is established 66 between the location capture unit 41 and the information center 22. Based upon the position data received, or other information as better understood further herein, the location of the intended target is then resolved 67. As will be better understood further herein, once the target location is uniquely resolved, communication between the location capture unit 41 and information center 22 may be terminated 77 unless necessary for the provision of the requested service. Finally, as shown in step 78, the requested service is provided to the user.

Although those of ordinary skill in the art will recognize many substantially equivalent alternatives, the preferred method for resolution of the target location is detailed in FIG. 10. As shown in FIG. 10, the first step 68 in resolution of the target is to identify the candidate targets based upon their location in relation to the position of the location capture unit 41 at the time the signal 48a or 48b is generated. According to the preferred embodiment of the present invention, this is accomplished by translating the received location information to a zone on a global map. The possible candidates are then defined as all of the fixed position advertisements 54 within that zone or within neighboring zones. In the next step 69, unlikely candidates are eliminated based upon their relative distances from the location capture unit 41 at the time of the signal. Although those of ordinary skill in the art will recognize that it would be possible to select the target location closest to the location capture unit 41, it is desirable to apply slightly more sophisticated processing in order to prevent resolution errors. In the preferred embodiment, candidates are only eliminated if they are at a much greater distance from the location capture unit 41 than is the likely candidate or candidates. Additionally, the threshold distance to be applied may vary with the type of fixed position advertisement 54. In this manner, the present invention accounts for the fact that a roadside sign 55, such as a large billboard with commercial offering information 56, may be visible at a much greater distance than would be a “Home For Sale” sign 57, with its commercial offering information 58.

If the resolution of the target is at this point successful, i.e., there is only one likely candidate remaining, then the type of service requested is identified at the data server 23. This identification may then be used to determine whether it is appropriate to terminate communication 77 between the information center 22 and the location capture unit 41, thereby minimizing data charges. If, on the other hand, the target resolution is not yet successful, i.e., there remains more than one candidate target, other collected information may then be used to further attempt resolution 73. For example if merely comparing the distances 70 to the candidate targets proves insufficient to identify the intended fixed position advertisement 54, the directional field of view 72, as obtained through the directional indicator 52, or the direction of travel, as determined by the GPS receiver 49, may be utilized to determine which fixed position advertisement 54 the user was likely to have been looking at when the signal 48a or 48b was generated. Again, if the resolution is at this point successful, the type of service may be identified 71.

If at this point the target has not yet been successfully resolved, however, user input may be applied 74, if desired. By way of example, such user input may be gathered by utilizing speech synthesis/recognition implemented through the public data network 36 to the user's wireless telephone 42 with a request for more information. In this manner, the user may be prompted to respond, for example, by speaking to indicate which commercial offering the user is considering. The user's response may then be transmitted back through the user's wireless telephone 42 to the information center 22 where the instruction may then be carried out. If no user input is available, however, such as would be the case if communication was interrupted communication prior to successful target resolution, the system must at this point must fail 75. Upon failure, however, a communication may nonetheless still be transmitted through electronic mail or other equivalent means notifying the user that the request cannot yet be fulfilled. This transmission may also include instructions or choices for response whereby the request may ultimately be fulfilled. For example, the electronic mail may allow the user to reply to a selection of reply addresses in order to effect the user's intention. On the other hand, the information requested by the user may be pre-positioned upon the web server 27 in which case the user would be provided with a URL address for each likely candidate. Finally, in the event of a resolution failure, all open communications between the location capture unit 41 and the information center 22 are terminated 76 in order to prevent further data charges.

Turning now to FIG. 11, details of the various services that may be provided are shown. In one aspect of the present invention, signaling at a particular roadside advertisement 55 may indicate that the user wishes to be connected by wireless telephone 42 to a business call center 32 such as, for example, a hotel chain reservations line. The call pass through function 79 is then selected as the identified service and initiated by dialing 80 the call center 32. If payment information is required for completion of the call, such as would be the case if the user wished to be connected to a “900” telephone number or automatically make a hotel reservation or the like. For example, payment information is then passed 81 to the call center 32. In any case the service is completed by performing a call transfer disconnect 82, leaving the user connected in voice communication with the business call center 32. As will be apparent to those of ordinary skill in the art, if the service is identified as the call pass through routine 79, communication must not be terminated in step 77.

In many cases, it is envisioned that the user will simply desire information to be transmitted via electronic mail or otherwise to a business or residence 60. In this case, an information request 83 is fulfilled by simply transmitting 84 the desired information from the electronic mail server 28 through the Internet 62, allowing receipt by the user of the information at his or her residence 60 through his or her own Internet connection 61 without the necessity for actually talking with a sales person. In the case, for example, of a house for sale, this electronic mail may include multi-media components. In the exemplary case, a virtual tour of the home for sale may be generated on the multi-media server 29 and attached to the E-mail to be transmitted.

In another aspect of the information request 83, it may be that the user wishes to be contacted by the ultimate service provider or product manufacturer. In this case, the user's identity may be transmitted through the Internet 62 to the manufacturer 33 or service provider over their own Internet connection 34. The manufacturer 33 or service provider may then initiate contact with the user in any manner appropriate to the offered good or service and authorized by the user. For example, the user utilizing the present invention to contact a hotel or restaurant reservations clerk may wish that the hotel or restaurant contact the user by cellular telephone. In this manner, the user is spared cellular airtime charges until such time as a reservations clerk is available to actually speak with the user.

In yet another aspect of the present invention, it may be that the user desires to actually consummate a purchase 85 as a result of generating a signal via brain-actuated control device 48a or switch/button 48b. Such a purchase request 85 may be fulfilled either by passing the order information to the manufacturer or by drop shipping. In the former case, the user's pertinent profile information, such as address and credit card number, are simply E-mailed to the manufacturer along with details of the product order. The manufacturer may then utilize any commercial delivery service 35 for fulfillment of the user's request. In the latter case, the user's credit card information may be processed 86 at the information center 22 whereafter the order can be shipped 87 without delay.

Finally, an interactive session may be established 89 with the user as a result of a generated signal from brain-actuated control device 48a or switch/button 48b. In this case, the information center 22 provides the user with a series of synthesized voice prompts 90 and collects 91 responses entered into the user's telephone keypad or other available data input system, such as a virtual input device. As with the call pass through function 79, the user interactive session 89 requires that the communication with the user be maintained until all responses are collected. At this time, however, the communication may then be terminated 92. In an alternate embodiment of the interactive session 89, the user may interface with the information center 22 through his or her web browser capable wireless telephone 43 or through his or her handheld computing device 46 and wireless MODEM 44 or through any other substantially equivalent mode of communication. This embodiment of the interactive session 89 can include a mixed reality simulation of, for example, a customer service representative who can subsequently interact with the user in a natural manner utilizing, for example, speech recognition.

In an extension of the interactive session function 89 and the purchase request function 85, the present invention may be utilized to interactively consummate a purchase. For example, in one implementation of this feature, the principles of the present invention may be advantageously employed to enable a user to select and purchase a number of movie, or other, admission tickets, thereby bypassing long ticket booth lines. This is particularly advantageous when considering that delays incurred in line, which in fact may cause one to actually miss a show time, are likely caused by the volume of persons present who seek tickets to entirely different showings.

In operation, the user seeking tickets to a particular event simply moves to within the proximity of the ticket outlet and, thereafter, generates a signal on his or her location capture unit 41. The target event is then resolved, as previously described, and an interactive session 89 is established between the user and the information center 22. A virtual customer service representative, for example, could then materialize within the user's visual field and interact with the user in a natural way. The user may thereby then select the particular event, the show time, the number of tickets required and the like and/or may provide information regarding special requirements such as for seniors' or children's tickets or disabled access or seating. As previously described, the user's interaction with the information center 22 may be through cellular or other wireless telephone 42, web browser capable wireless telephone 43, handheld computing device 46 and wireless MODEM 44 or any substantially equivalent mode of communication. In the case wherein the user decides that he or she does in fact wish to make a ticket or other purchase, pertinent profile information may be utilized to process the user's request as previously discussed.

It is noted that many readily available handheld computing devices 46 comprise an infrared or wireless communications link for short range transmission of data to and from the handheld computing device. As a result, although any of the previously mentioned devices may be utilized for the interactive session 89 between the user and the information center 22, short range communication capable handheld computing devices 46 may be utilized to additional advantage for this particular aspect of the present invention. In particular, an authorization code may, during the interactive session 89, be downloaded from the information center 22 to the user's handheld computing device 46. The handheld computing device 46 may then be taken with the user to the event venue and there utilized as an electronic ticket, thereby allowing the user to gain immediate access without stopping at a will call window or the like for identification and ticketing. Although the processing of the electronic ticket may be monitored, those of ordinary skill in the art will recognize many possibilities for implementation of this function though a completely automated and unattended system. In this manner, this aspect of the present invention is particularly adapted to ensure the fastest possible access to even the most crowded events, including not only movie theaters but also theme parks, concert events, sporting events and the like. Additionally, those of ordinary skill in the art will recognize that this aspect of the present invention may also be advantageously implemented in other applications such as, for example, streamlined passage through an automated car wash.

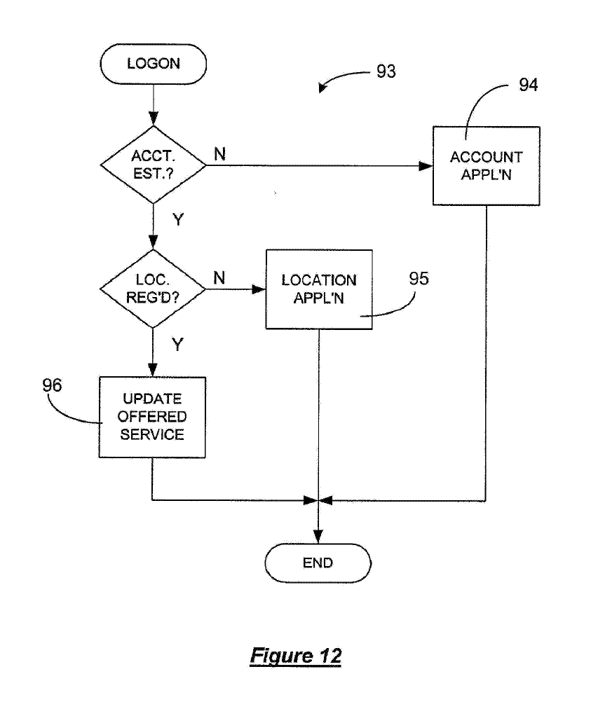

Turning now to FIG. 12, details of the advertiser's account setup and maintenance function 93 are provided. Upon logging-on to the system, it is first determined whether the advertising client has an account with the service provider. If not, the potential client is presented with an account application 94. The account application may be utilized by the service provider to determine what type of services, of those detailed in FIG. 11, the client may utilize. In the case of an established client, the system determines whether the fixed position advertisement 54 is registered. If not, a location application is presented 95. This location application may be utilized by the service provider to determine the location and orientation of the advertisement 54 for entry into the data server 23. Finally, in the case of an established location under the control of an established client, the advertiser may be presented with a screen for update of content specific information 96. In this manner, the advertising client may directly access the system 20 as advertising requirements change. For example, the client may upload a new file for transmission to any user that clicks on a particular controlled advertisement or in the case of a house for sale, for example, the client advertiser may change the asking price.

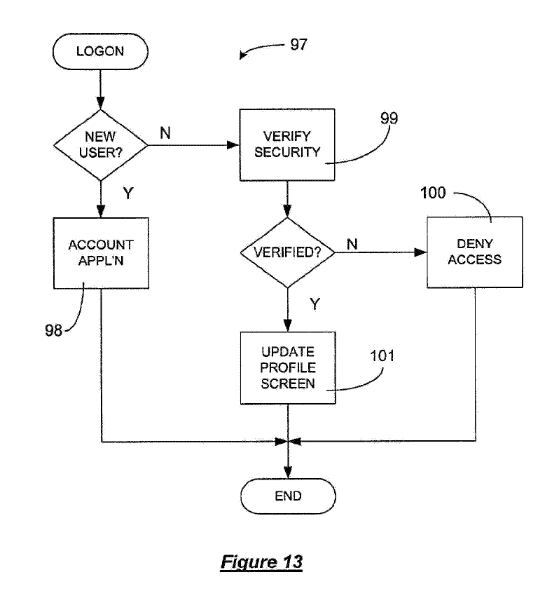

As shown in FIG. 13, the user's account setup and maintenance function 97 allows new users to provide billing and other preference information via an account application 98. Likewise existing users may access the system 20 to update this information 101. In the preferred embodiment of the present invention, however, a security step 99 is implemented to ensure that unauthorized users are denied access to others' accounts.

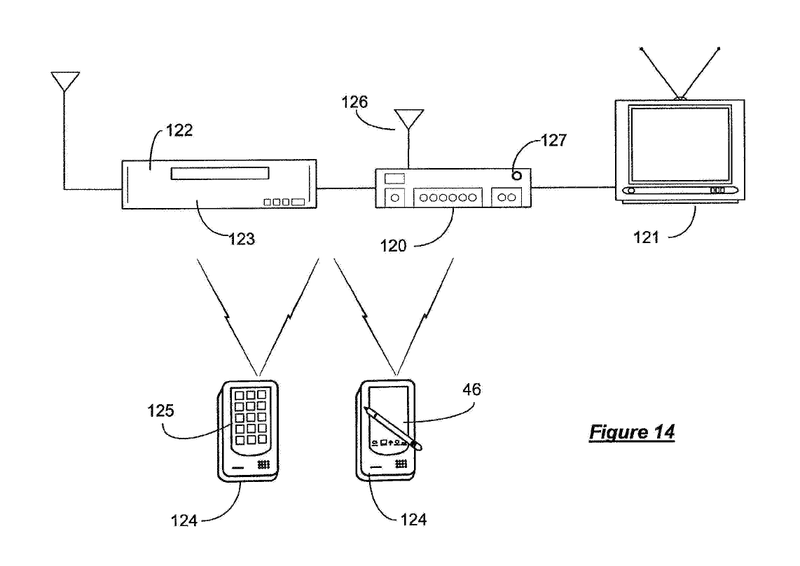

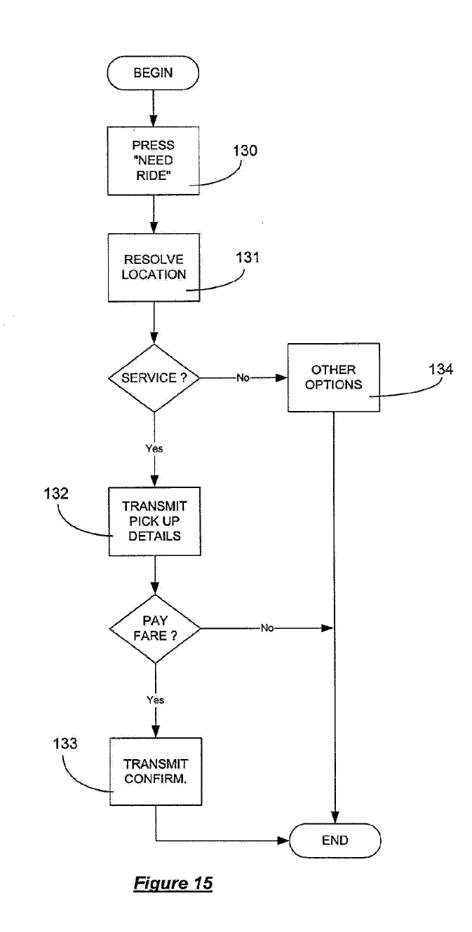

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, as shown in FIG. 14, the concepts of the present invention are readily extendible for enhanced effectiveness of television or radio advertisement. In the case of television advertisement, an unused line in the blanking interval of the NTSC, or other, video signal may be utilized to transmit advertiser information to a data capture unit 120 interposed the user's television 121 and tuning device 122, such as a set-top box 123 or cable tuner. When the user wishes to respond to commercial offering information 56 displayed as part of the advertisement, he or she presses a switch/button 48b on a provided device 124 causing a signal to be transmitted to the data capture unit 120, which then stores the user's desire to take further action with respect to the advertisement tuned in at that time. While the provided device 124 may be specifically adapted for use with the television 121, such as a modified remote control device 125, those of ordinary skill in the art will recognize that the device 124 may also comprise the same location capture unit 41 utilized in other aspects of the present invention. For example, a personal computing device 46 with an infrared or wireless capability may be adapted to transmit the user's intention to the data capture unit 120 through a provided radio receiver 126 or infrared receiver 127. Likewise headset 50 associated with location capture unit 41 can produce a virtual menu or television selection guide to further enhance the experience.

In the case of radio advertisement, a specially modified radio, e.g. a radio equipped with RDS, may be provided in order that the data capture unit 120 may have available information as to what radio station the user is listening. Upon hearing an announcement to “click” now, the user may respond as previously described. In either the television or radio example, it is to be understood that the user side 40 may comprise any previously discussed combination of elements such that any previously discussed service may be provided. For example, the data capture unit 120 may be utilized as an automated telephone dialer for connection of the user with a call center 32, restaurant or hotel reservations line or the like. Finally, aspects of the present invention may be extended to a set of applications based upon a user-fee based business model. In particular, it is envisioned that the position location and communication aspects of the previously described embodiments may be implemented within a non-advertisement-based context, such as may exist in the provision of public goods. As one example of such an application, it is noted that the position location and communication aspects of the invention may be utilized to provide a 3D virtual tour guide for sight-seeing in the public parks, historic places or other recreation areas. The virtual tour guide would appear in the user's real-space via headset 50 and accompany the user throughout the tour providing interesting or even vital information. In this case, the user may be directly charged (according to billing information in the user's profile) or the service may be provided as part of the admission fee to the park or like venue.

In a further extension of this model, it is also noted that the foregoing features of the invention may be implemented in order to provide landmark identification for the visually impaired or cognitively disabled persons. In particular, such a person may traverse a historical location and automatically (or upon “signaling”) receive audio information regarding the historical significance of his or her exact position within the location. With the use of a location capture unit 41 having directional capability (such as provided with a flux gate compass or the like), the user may receive additional or tailored information based upon the direction in which he or she is facing.

In yet a further extension of the present invention, provision may be made for a taxi cab, Uber car or shuttle application, as shown in FIG. 15. In this application, a special “need ride” signaling option may be incorporated in location capture unit 41 to facilitate hailing rides for users who do so on a frequent basis. As will be better understood further herein, however, those of ordinary skill in the art will also recognize that this application may be implemented utilizing a location capture unit 41 having only a brain-actuated control device 48a or switch/button 48b. In any case, the user may utilize the location capture unit 41 to indicate his or her desire for service from a taxi, Uber car or shuttle. Upon signaling 130, the processing side 21 of the system 20 resolves 131 the user's location, substantially as described with respect to FIG. 9. In this case, however, either through the selection of a special “need ride” type signal or through the solicitation of further input from the user, the system 20 of the present invention determines that the user requires taxi, Uber car or shuttle service.

At this point, the processing side 21 determines whether such service is available based upon the user's resolved location. As will be understood by those of ordinary skill in the art, this determination may involve communication between the processing side 21 and the taxi, Uber or shuttle service in any of the manners previously described or the substantial equivalent thereof. Additionally, this determination may also be at least in part based upon system knowledge of the exact location and status (through the provision of GPS receivers within cabs or shuttles) of affiliated vehicles Should it be determined that the desired service is available, pickup details are transmitted 132 to both the user and the taxi or shuttle service. As will be understood by those of ordinary skill in the art, transmission to the transportation service may be through the service dispatcher or may be through direct communication with the driver via an MR display worn by the driver of the vehicle. It is envisioned that one possibility includes rendering a 3D virtual representation of the driver and passenger to enable them to virtually “meet”. In any case, in the preferred embodiment of the present invention details regarding the identity of the user are transmitted to the driver and details regarding the service and driver are transmitted to the user. In this manner, the present invention betters upon the prior art inasmuch as the present invention provides heightened security for both the user in need of a ride and the driver called upon to provide the ride.

Additionally, the implementation of the present invention carries with it the additional benefit of enabling the user to automatically pay any required fare or fee utilizing credit card or other financial information maintained upon the data server 23. In fact, it is envisioned that taxi, Uber or shuttle services taking advantage of the present invention may be able to entirely dispense with the necessity for carrying cash. To this end, the user is preferably given an option at the end of the ride to pay the fare utilizing the location unit 41. To pay the fare 133, the user need only generate a signal on the location capture unit 41, whereafter authorization for the charge may be processed through the processing side 21. As will be understood by those of ordinary skill in the art, indication of the user's desire to pay the fair may be through direct communication between the location capture unit 41 and the processing side 21 or may be through a transmission between an appropriately configured location capture unit 41 and dashboard or otherwise mounted receiving equipment provided within the taxi or shuttle vehicle. Of course, tips may be added to the fare at this time at the user's discretion. Likewise, it is noted that should an appropriate service not be available, other option 134 such as voice connection 79 to a standard taxi service or Uber car may be provided as previously described.

Finally, it will be apparent to those of ordinary skill in the art that this feature of the present invention can still be further extended to take advantage of the extraordinary communications connectivity provided through the network of the present invention For example, while the user is awaiting his or her taxi he or she may interact with a virtual taxi dispatcher or proximate Uber driver to upload destination information to the processing side 21 through a handheld computing device 46, smart phone or the like. The information center 22 may then generate and transmit to the driver detailed directions for ensuring that the user is expeditiously delivered to his or her desired destination. In any case, because the scope of the present invention is much broader than any particular embodiment, the foregoing detailed description should not be construed as a limitation of the scope of the present invention, which is limited only by the claims appended hereto.

What is claimed is:

1. A method for providing interaction with a commercial offering, said method comprising the steps of: locating a portable mixed reality device at a terrestrial position at a point in time; identifying a commercial offering in proximity to said portable mixed reality device at said point in time based upon said terrestrial position; and providing real-time interaction specific to said commercial offering.

2. The method as recited in claim 1, wherein said locating step comprises receiving a navigational signal at said portable mixed reality device.

3. The method as recited in claim 2, wherein said providing a real-time interaction step comprises the step of paying for goods or services, said goods or services being determined by the identification of said commercial offering.

4. The method as recited in claim 2, wherein said providing a real-time interaction step comprises paying an admission fee.

5. The method as recited in claim 4, wherein said providing a real-time interaction step further comprises generation within said portable mixed reality device of an access code.

6. The method as recited in claim 5, wherein said portable mixed reality device is adapted to communicate said access code to a receiver associated with said commercial offering.

7. A method for utilizing a transportation service, said method comprising the steps of: locating a portable mixed reality device at a terrestrial position; determining the availability of a transportation service based upon said terrestrial position; and interacting with said transportation service.

8. The method as recited in claim 7, wherein said locating step comprises receiving a navigational signal.

9. The method as recited in claim 8, said method further comprising the step of paying a service charge.

10. The method as recited in claim 9, wherein said service charge comprises a ride fare.

11. The method as recited in claim 7, wherein said interacting with said transportation service step comprises a mixed-reality computer generated image of a customer service representative.

12. The method as recited in claim 7, wherein said interacting with said transportation service step comprises a mixed-reality computer generated image of a driver.

13. A method for providing interaction with a commercial offering, said method comprising the steps of: locating a portable mixed reality device at a terrestrial position at a point in time; identifying a commercial offering in proximity to said portable device at said point in time based upon said terrestrial position; signaling a receiver associated with said commercial offering, and providing real-time interaction specific to said commercial offering.

14. The method as recited in claim 13, wherein said signaling a receiver step comprises activating a brain actuated controlled signaling device.

15. The method as recited in claim 13, wherein said signaling a receiver step comprises activating an electrical switch or button.

16. A method for providing interaction with a virtual tour guide, said method comprising the steps of: locating a portable mixed reality device at a terrestrial position at a point in time; signaling a request for a guided tour, rendering a computer generated tour guide appearing within the visual field of a user; and providing real-time interaction specific to said tour.
